(19) United States
(12) Patent Application Publication
(10) Pub. No.: US 2021/0380184 A1
(43) Pub. Date: Dec. 9, 2021

(54) TRACKED VEHICLE FOR PREPARING SKI TRAILS

(71) Applicant: PRINOTH S.P.A., Vipiteno (IT)

(72) Inventor: Gregor Maurer, Vipiteno (IT)

(21) Appl. No.: 17/283,871

(22) PCT Filed: Oct. 11, 2019
(86) PCT No.: PCT/IB2019/058702

§ 371 Date: Apr. 8, 2021

(30) Foreign Application Priority Data
Oct. 12, 2018 (IT) 102018000009419

(51) Int. Cl. B62D 55/108; B62D 29/00; B62D 55/30; B62D 55/14

(52) U.S. Cl. CPC B62D 55/108; B62D 29/008; E01H 4/02; B62D 55/14; B62D 55/30

(57) ABSTRACT

A tracked vehicle for preparing ski trails; the tracked vehicle comprising: a frame; two sets of wheels arranged on opposite sides of the frame; two tracks, each of which is respectively run over by one of the two sets of wheels; and at least one support device for each set of wheels, which is coupled to at least two wheels of the set of wheels and is connected in an articulated way to the frame in order to couple the at least two wheels of the set of wheels to the frame; wherein the support device comprises an outer main body, which defines an inner cavity and wherein the inner cavity is at least partially filled with metal foam.

### PRIORITY CLAIM

This application is a national stage application of PCT/IB2019/058702, filed on Oct. 11, 2019, which claims the benefit of and priority to Italian Patent Application No. 102018000009419, filed on Oct. 12, 2018, the entire contents of which are each incorporated by reference herein.

### TECHNICAL FIELD

The present disclosure relates to a tracked vehicle for the preparation of ski trails.

In particular, the present disclosure relates to a tracked vehicle comprising a frame; two sets of wheels arranged on opposite sides of the frame; two tracks arranged around the respective sets of wheels; and at least one support device for each set of wheels coupled to at least two wheels of the set of wheels and connected to the frame to couple the at least two wheels of the set of wheels to the frame.

### BACKGROUND

A disadvantage of certain tracked vehicles of certain of the prior art is that the tracked vehicle has unwanted vibrations.

### SUMMARY

One purpose of the present disclosure is to manufacture a tracked vehicle capable of reducing certain of the drawbacks of certain of the prior art.

According to the present disclosure a tracked vehicle for preparing ski trails, the tracked vehicle, is manufactured that comprises:
a frame;
two sets of wheels arranged on opposite sides of the frame;
two tracks, each of which is respectively run over by one of the two sets of wheels; and
at least one support device for each set of wheels coupled to at least two wheels of the set of wheels and connected in an articulated way to the frame to couple the at least two wheels of the set of wheels to the frame; wherein the support device comprises an outer main body defining an inner cavity and wherein the inner cavity is at least partially filled with metal foam.

Such a configuration of the present disclosure provides that the vibrations transmitted from the support device to the frame are reduced by filling the cavity at least partially with the metal foam. This configuration enables one to modify and select the vibration modes of the support device and, consequently, how the vibrations are transmitted from the wheels to the frame that the support device connects to each other.

According to certain embodiments, the inner cavity is divided into sections, and at least one of the sections is filled with metal foam.

According to certain embodiments, the density of the metal foam is within the range between 0.4 g/cm3 and 1 g/cm3.

It should be appreciated that in accordance with the present disclosure, one can adjust the resistance of the support device and its natural frequency and the vibration modes by varying the value of the density of the metal foam. That is, by increasing the density of the metal foam, the natural frequency increases and the frequencies of the vibration modes increase. In a non-limiting embodiment of the present disclosure, the density of the metal foam is 0.7 g/cm3.

According to another embodiment, the section filled with metal foam extends along the inner height of the main body or along the inner length of the main body.

According to another embodiment, the sections filled with metal foam are at least two, wherein one extends along the inner height of the main body and the other extends along the inner length of the main body.

According to another embodiment, there are at least two sections filled with metal foam, wherein the density of the metal foam of one section is different from the density of metal foam of the other section.

According to another embodiment, the at least one section filled with metal foam extends at least partially along the edges of the main body, in particular the section extends completely along the edge of the main body on the inside.

According to another embodiment, the support device comprises three openings passing through the width of the device, each of which is configured to couple a wheel or an articulated joint to the main outer body, and at least one section filled with the metal foam extends around one of the three openings. In certain embodiments, the support device comprises three sections filled with metal foam, wherein each section filled with metal foam wraps around a respective opening.

According to another embodiment, the support device comprises an articulated connection joint, which is housed within one of the openings of the body of the support device, and is coupled to the frame to couple the support device to the frame in an articulated way.

According to another embodiment, the at least two of the set of wheels are support wheels, in particular freely rotating wheels, and are coupled to the support device through two of the three openings, in particular the two end openings.

According to another embodiment, the set of wheels comprises a drive wheel, such as a rear wheel; and a track-adjustment wheel, such as a front wheel having a mobile position with respect to the frame to tension the track.

According to another embodiment, the at least two wheels are intermediate wheels between the track-adjustment wheel and the drive wheel, such wheels are freely rotating wheels.

According to another embodiment, the support device is connected to the frame via a shock-absorber assembly, in particular the shock-absorber assembly is interposed between the support device and the frame to certain embodiments, the shock-absorber assembly is of variable stiffness and/or variable geometry; in particular, the shock-absorber assembly comprises is hydraulic cylinder such as of the double-acting type. in various embodiments, the shock-absorber assembly is mechanical and/or hydraulic and/or electromagnetic and/or of the air-suspension type, or any combination of the above.

According to another embodiment, the support device has a first support element, supporting one of the at least two wheels of the set of wheels; and a second support element, supporting another of the at least two wheels of the set of wheels; and wherein the first support element and the second support element are connected to each other either in an elastically flexible way or via a first articulated joint at a first point. In certain embodiments, the support device comprises at least one additional articulated joint to couple the first element with the second element in an articulated way.

According to another embodiment, the first and second support elements are connected to each other via a shock absorber, in particular at one second point, at least, that is different from the first point. In various embodiments, the shock absorber is of variable stiffness and/or variable geometry and the shock absorber is mechanical and/or hydraulic and/or electromagnetic and/or of the air-suspension type, or any combination of the above.

According to another embodiment, the articulated connection joint is partly housed on the first and/or second support element.

### BRIEF DESCRIPTION OF THE DRAWINGS

Other features and advantages of the present disclosure will be more apparent from the following description of a non-limiting embodiment thereof, with reference to the figures, wherein:

FIG. 1 is a side elevation view, with parts removed for clarity, of a tracked vehicle constructed in accordance with the present disclosure;

FIG. 2 is a schematic view from above of the tracked vehicle in FIG. 1, with some parts removed for the sake of clarity;

FIG. 3 is a perspective view of a detail of the tracked vehicle constructed in accordance with an embodiment of the present disclosure;

FIG. 4 is a perspective view, with parts shown in cross-section, of a detail of the tracked vehicle constructed in accordance with an embodiment of the present disclosure;

FIG. 5 is a perspective view, cut along a cross-section, of a detail of the tracked vehicle constructed in accordance with one embodiment of the present disclosure;

FIG. 6 is a side elevation view, with parts removed for clarity, of a tracked vehicle constructed in accordance with an alternative embodiment of the present disclosure; and

FIG. 7 is a perspective view, with parts shown in cross-section, of a detail of the tracked. vehicle constructed in accordance with another embodiment of the present disclosure in FIG. 4.

### DETAILED DESCRIPTION

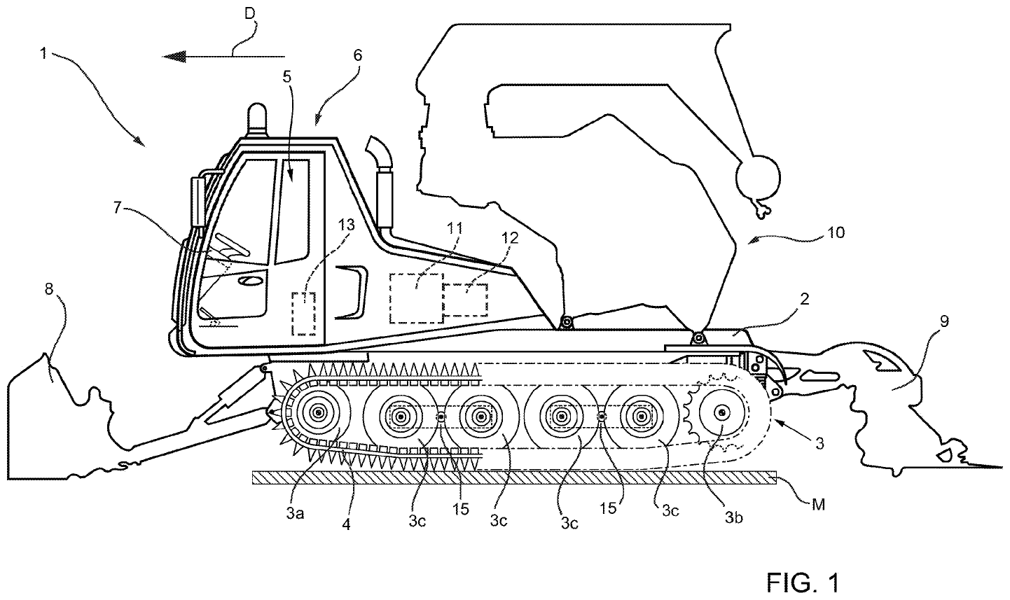

With reference to FIG. 1, the number 1 indicates, as a whole, a tracked vehicle and, in particular, a tracked vehicle for the preparation of ski trails, designed to be advanced in a direction of travel D.

With reference to FIG. 1, the tracked vehicle 1 comprises a frame 2; two sets of wheels 3 (only one visible in FIG. 1) in a variable configuration and arranged on opposite sides of the frame 2; and two tracks 4, each of which is wrapped around one of the two respective sets of wheels 3.

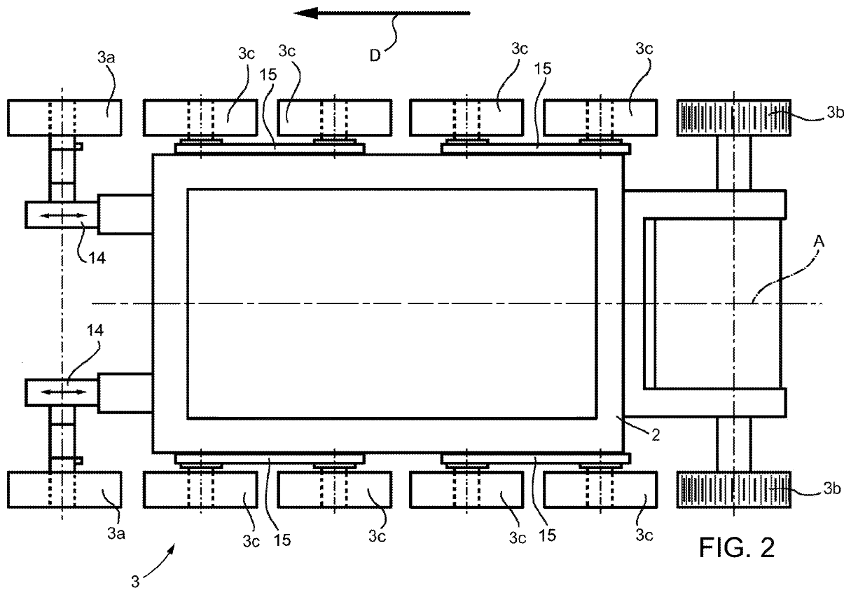

With reference to FIGS. 1 and 2, the frame 2 extends along an axis A and supports the sets of wheels 3.

Each set of wheels 3 comprises a front wheel 3a, a rear wheel 3b, and four central wheels 3c arranged between the front wheel 3a and the rear wheel 3b. The wheel 3b is a drive wheel.

With reference to FIG. 2, each front wheel 3a is connected to the frame 2 by a carriage 14 that is coupled to the frame 2 in a sliding way along the direction of extension of the track 4 (in certain embodiments parallel to the direction of travel) via an actuator (not shown in the figures) to keep the respective track 4 in tension for any configuration assumed by the remaining wheels of the set of wheels 3.

With reference to FIG. 1, the tracked vehicle 1 comprises a control unit 13; a cabin 6; a user interface 7 arranged in the cabin 6; a blade 8 that is supported at the front by the frame 2; a cutter 9 that is supported at the rear by the frame 2; a winch assembly 10 that is attached above the frame 2; an internal combustion engine 11, and a power transmission 12 operatively connected to the internal combustion engine 11; to the drive wheels 3b; to the blade 8; to the cutter 9; and to the winch assembly 10. In different embodiments, the power transmission 12 can be hydraulic or electric, or a hydraulic and electric combination.

The track configurations 4 depend on the configurations of the respective sets of wheels 3. In particular, each set of wheels 3 is adjustable between two limit configurations to adjust a portion of the track in contact with the snowpack M.

With reference to FIGS. 1 and 2, the central wheels 3c of each set of wheels 3 are coupled in groups of two to the respective support devices 15, which, in turn, are connected in an articulated way to the frame 2.

In the case shown in FIGS. 1 and 2 (which does not limit the present disclosure), the tracked vehicle 1 comprises a support device 15 for each pair of central wheels 3c of the set of wheels 3. In other words, each support device 15 is coupled to two central wheels 3c of the set of wheels 3, so that for each set of wheels 3, the tracked vehicle 1 comprises two support devices 15, Each support device 15 is coupled to two central wheels 3c.

In addition, each support device 15 couples the respective two central wheels 3c of the set of wheels 3 in an articulated way to the frame 2 to couple the at least two central wheels 3c of the set of wheels 3 to the frame 2.

With reference to certain of the figures, each support device 15 comprises three openings 23 passing through the width of the support device 15, in particular holes 23 extending along the width of the support device 15, Each through-opening 23 is configured to couple a wheel or articulated joint to the support device 15.

The support device 15 comprises an articulated connection joint 17, which, in certain embodiments, is housed within one of the openings 23 of the main body 18 of the support device 15, and is coupled to the frame 2 for coupling, in an articulated way, the support device 15 to the frame 2.

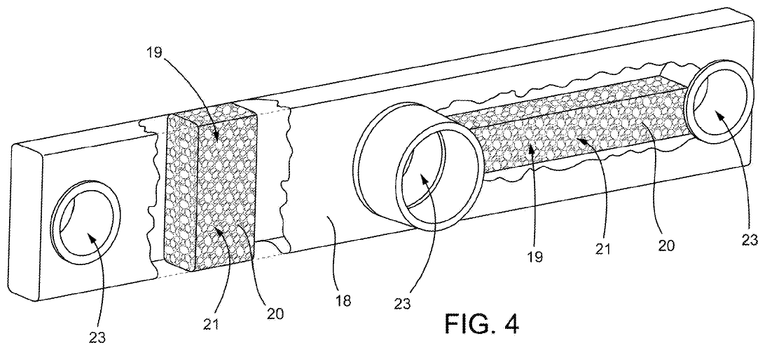

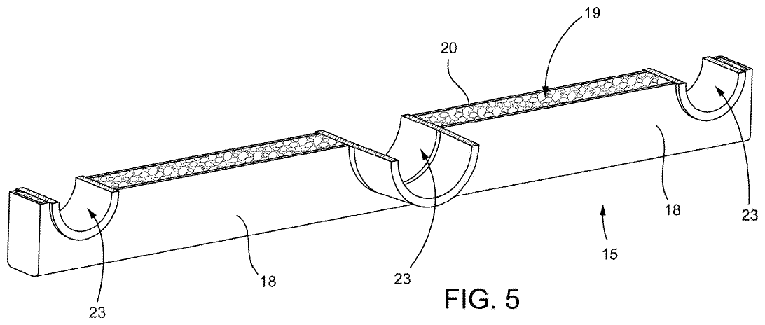

With reference to FIGS. 4 and 5, the support device 15 comprises a main outer body 18 that defines an inner cavity 19 and wherein the inner cavity 19 is at least partially filled with metal foam 20; in particular, in FIG. 5, the inner cavity 19 is completely filled with metal foam 20.

With reference to FIG. 4, the inner cavity 20 is divided into sections 21, and the sections 21 are filled with metal foam 20, in an alternative embodiment (not shown), not all the sections 21 are filled with metal foam 20.

In the non-limiting embodiment shown in FIG. 4, one of the sections 21 filled with metal foam 20 extends along the inner height of the main body 20, while another section 21 filled with metal foam 20 extends along the inner length of the main body. Depending on the vibration frequencies and/or vibration modes to attenuate, which sections to fill with the metal foam and in which directions these sections need to be extended are chosen.

In another embodiment of the present disclosure (not shown in the figures), for example, it is possible to fill one of the sections—either the one extending along the internal height of the main body or the one extending along the internal length of the main body—with metal foam.

In another embodiment of the present disclosure (not shown in the figures), there are more than two sections that extend in various directions in the inner cavity of the support device and one or more of these sections can be filled with metal foam depending on the vibration frequencies and/or vibration modes to attenuate.

According to another embodiment of the present disclosure (not shown in the figures), one section filled with metal foam extends at least partially along the edges of the main body, in particular the section extends completely along the edge of the main body on the inside.

In addition, it is possible to fill one or more sections that have different directions with metal foam in the inner cavity depending on the desired stifthess to give the support device, or to strengthen specific areas of the support device, In addition, the sections to be filled vary according to the total weight required for the support device.

In addition, the density of the metal foam is within a range between 0.4 g/cm3 and 1 g/cm3. In this way, the resistance of the support device and its natural frequency and vibration modes can be adjusted by varying the density of the metal foam. That is, by increasing the density of the metal foam, the natural frequency increases and the frequencies of the vibration modes increase. in a non-limiting embodiment of the present disclosure, the density of the metal foam is 0.7 g/cm3.

In another embodiment of the present disclosure, there are at least two sections filled with metal foam, wherein the density of the metal foam of one section is different from the density of metal foam of the other section.

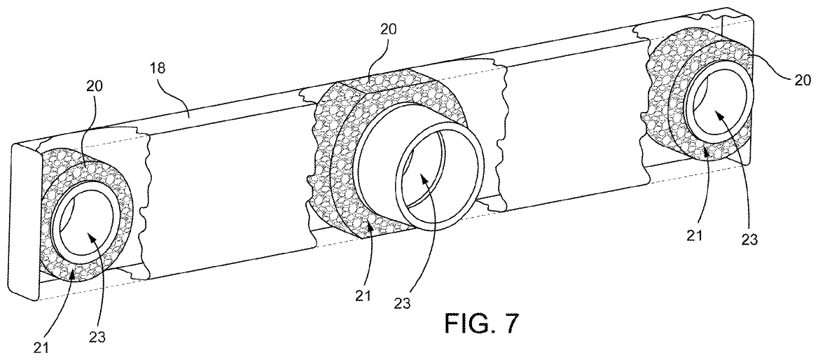

In accordance with the non-limiting embodiment of the present disclosure shown in FIG. 7, each of the three openings 23 is surrounded by a section 21 of the inner cavity 19 filled with metal foam 20. In another embodiment (not shown), one or two sections filled with metal foam are arranged around one or two through openings 23. In particular, in an embodiment (not shown), the through opening housing the articulated connection joint with the frame is surrounded by a section filled with metal foam while the other two openings are not surrounded by a section filled with metal foam. In another embodiment, the through openings that are coupled to the wheels are surrounded by sections filled with metal foam, while the through opening that houses the articulated joint that is coupled to the frame is not surrounded by a section filled with metal foam.

According to the present disclosure, any of the embodiments described above may be chosen depending on the vibration frequencies and/or vibration modes to, in different embodiments, dampen, and/or areas to strengthen the support device, and/or the desired weight of the support device, and/or the desired stiffness of the support device.

It should be appreciated that in accordance with the present disclosure, the vibrations transmitted from the support device to the frame are reduced by filling the cavity at least partially with the metal foam. Such a configuration enables one to modify and select the vibration modes of the support device and, consequently, how the vibrations are transmitted from the wheels to the frame that the support device connects to each other.

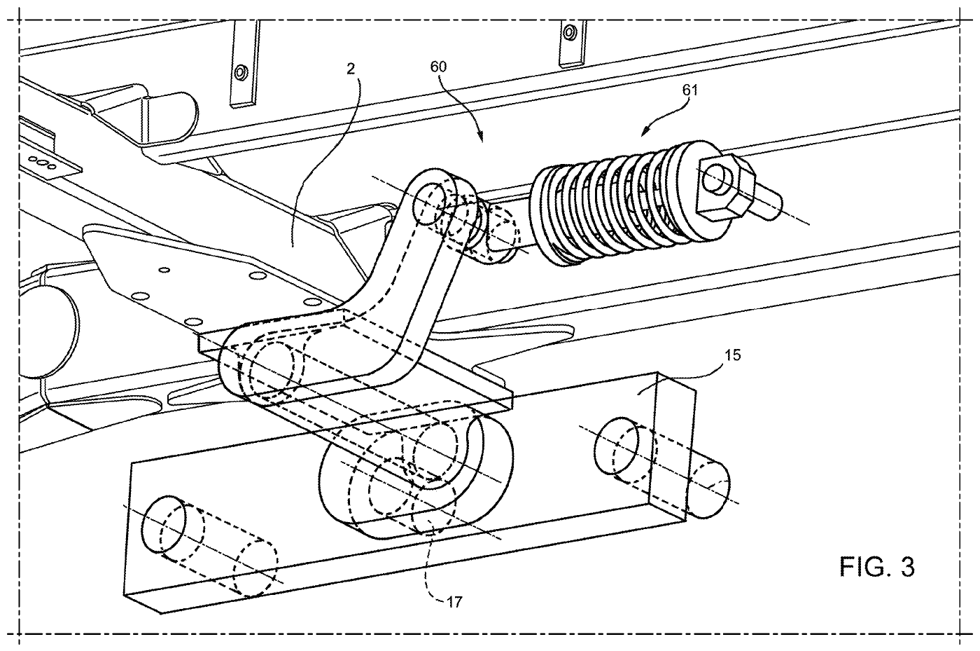

In the non-limiting embodiment of the present disclosure shown in FIG. 3, for each support device 15, the tracked vehicle 1 comprises a variable configuration and variable stiffness shock-absorber assembly 60 to connect the respective two central wheels 3c, in particular via the support devices 15, to the frame 2, to absorb any shocks and selectively vary the relative position between the central wheels 3c and the frame 2. In other words, each support device 15 can be connected via a structure that can, in certain embodiments, be articulated directly to the frame 2 or can be connected via the shock-absorber assembly 60 shown in FIG. 3.

In the non-limiting embodiment of FIG. 3, each support device 15 is connected to the frame 2 via a respective shock-absorber assembly 60. In particular, the shock-absorber assembly 60 has a variable stiffness and variable geometry so that the shock-absorber assembly's 60 response to shocks, and the position of the tracked vehicle with respect to the snow and the portion of the track in contact with the snow, can be varied.

The shock-absorber assembly 60 comprises a hydraulic cylinder 61, such as the double-acting type. In different embodiments, the shock-absorber assembly 60 can be of the mechanical and/or hydraulic and/or electromagnetic and/or air suspension type, or any combination of the above.

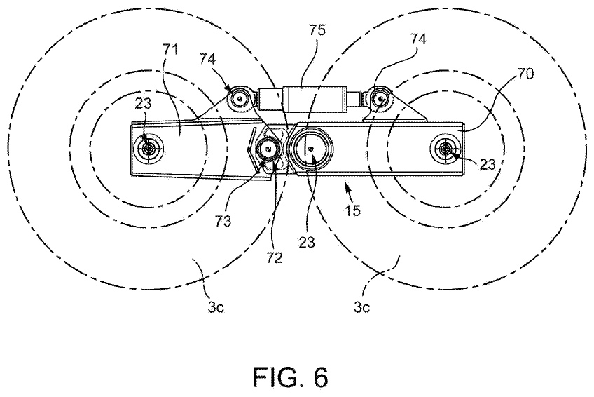

In the embodiment shown in FIG. 6 (which does not limit the present disclosure), the support device 15 has a first support element 70, which supports one of the at least two wheels 3c of the set of wheels 3; and a second support element 71, which supports another of the at least two wheels 3c of the set of wheels 3; and wherein the first support element 70 and the second support element 71 are connected to each other either in an elastically flexible way or via an articulated joint 72 at a first point 73. In a non-limiting embodiment, the support device 15 comprises additional articulated joints 74 to couple the first element 70 with the second element 71 in an articulated way such as via a shock absorber 75. In this embodiment, the sections filled with metal foam 20 may be located in the first support element 70 or in the second support element 71 or in both. In particular, the sections filled with metal foam 20 can be arranged around the articulated joint 72 and/or the additional articulated joints 74 either on the first element 70 or on the second element 71 or on only one of them.

Furthermore, it is evident that the present disclosure also covers embodiments not described in the detailed description and equivalent embodiments, which fall within the scope of protection of the appended claims. That is, the scope of protection of the present disclosure is defined by the claims which cover variants not specifically described and equivalent embodiments. Accordingly, various changes and modifications to the presently disclosed embodiments will be apparent to those skilled in the art.

1-15. (canceled)

16. A tracked vehicle configured to prepare a ski trail, the tracked vehicle comprising:
a frame;
a set of wheels arranged on a side of the frame;
a track associated with the set of wheels; and
a support device for the set of wheels, the support device comprising a main body defining an inner cavity at least partially filled with a metal foam, wherein the support device is coupled to at least two wheels of the set of wheels and articulatedly connected to the frame to couple the at least two wheels of the set of wheels to the frame.

17. The tracked vehicle of claim 16, wherein the inner cavity is divided into a plurality of sections and at least one section of the plurality of sections is filled with the metal foam.

18. The tracked vehicle of claim 17, wherein the at least one section filled with the metal foam extends along at least one of: an inner height of the main body and an inner length of the main body.

19. The tracked vehicle of claim 17, wherein the at least one section filled with the metal foam comprises at least two sections of the plurality of sections, a first one of the at least two sections extends along an inner height of the main body and a second one of the at least two sections extends along an inner length of the main body.

20. The tracked vehicle of claim 17, wherein the at least one section tilled with the metal foam comprises at least two sections of the plurality of sections and a density of the metal foam of a first one of the at least two sections is different from a density of the metal foam of a second one of the at least two sections.

21. The tracked vehicle of claim 17, wherein the at least one section filled with the metal foam at least partially extends along at least one edge of the main body.

22. The tracked vehicle of claim 17, wherein the support device defines three through openings through a width of the main body, the at least one section filled with the metal foam extends around one of the three through openings, and each of the through openings is configured to couple to the main body one of: a. wheel and an articulated joint.

23. The tracked vehicle of claim 22, wherein the at least one section filled with the metal foam comprises three sections of the plurality of sections, each section extending around a respective one of the three through openings.

22. The tracked vehicle of claim 22, wherein the support device comprises an articulated connection joint housed within one of the three through openings, the articulated connection joint being coupled to the frame to articulatedly couple the support device to the frame.

25. The tracked vehicle of claim 22, wherein the at least two wheels of the set of wheels are freely rotatable support wheels coupled to the support device through two of the three through openings.

26. The tracked vehicle of claim 25, wherein the at least two wheels of the set of wheels are freely rotatable intermediate wheels between a track-adjustment wheel and a drive wheel.

27. The tracked vehicle of claim 16, wherein the set of wheels comprises a rear drive wheel and a front track-adjustment wheel moveably positioned with respect to the frame to tension the track.

28. The tracked vehicle of claim 16, wherein a density of the metal foam is in the range from 0.4 g/cm³ to 1 g/cm³.

29. The tracked vehicle of claim 16, wherein the support device is connected to the frame via a shock-absorber assembly interposed between the support device and the frame.

30. The tracked vehicle of claim 29, wherein the shock-absorber assembly has at least one of a variable stiffness and a variable geometry.

31. The tracked vehicle of claim 16, wherein the support device comprises:
a first support element that supports one wheel of the at least two wheels of the set of wheels, and
a second support element that supports another wheel of the at least two wheels of the set of wheels, and
the first support element and the second support element are one of: elastically flexibly connected together and connected together via a first articulated joint at a first point.

32. The tracked vehicle of claim 31, wherein the support device comprises a second articulated joint to articulatedly couple the first element to the second element.

33. The tracked vehicle of claim 31, wherein the inner cavity around the first articulated joint is filled with the metal foam in at least one of the first support element and the second support element.

34. the tracked vehicle of claim 16, further comprising:
another set of wheels arranged on an opposite side of the frame;
another track associated with the other set of wheels; and
another support device for the other set of wheels, the other support device comprising a main body defining an inner cavity at least partially filled with the metal foam, wherein the other support device is coupled to at least two wheels of the other set of wheels and articulatedly connected to the frame to couple the at least two wheels of the other set of wheels to the frame.

35. A support device for a tracked vehicle, the support device comprising:
a main body defining an inner cavity at least partially filled with a metal foam, wherein:
the support device a configured to be coupled to at least two wheels of a set of wheels arranged on a side of the tracked vehicle, and
the support device is configured to be articulatedly connected to a frame of the tracked vehicle to couple the at least two wheels of the set of wheels to the frame of the tracked vehicle.

36. The support device of claim 35, wherein the inner cavity is divided into a plurality of sections and at least one section of the plurality of sections is filled with the metal foam.
